(19) United States
(12) Patent Application Publication
(10) Pub. No.: US 2004/0030747 A1
(43) Pub. Date: Feb. 12, 2004

(54) Method and apparatus for generating an operation or processing load

(75) Inventor: Lars Oppermann, Hamburg (DE)

Correspondence Address: Forrest Gunnison, Gunnison, McKay & Hodgson, L.L.P., Suite 220, 1900 Garden Road, Monterey, CA, 93940, US

(73) Assignee: Sun Microsystems, Inc.

(21) Appl. No.: 10/630,605

(22) Filed: Jul. 29, 2003

(30) Foreign Application Priority Data
Jul. 29, 2002 (EP) 02 016 820.9

(51) Int. Cl. G06F 15/16

(52) U.S. Cl. 709/203

(57) ABSTRACT

A method and apparatus generate an operational load condition at a server. A plurality of communication sessions is established on a client and test input operations are accessed and produced in each of the communication sessions to generate a realistic operational load condition. The communication sessions and/or the playback operations are started with appropriate time delays.

### BACKGROUND OF THE INVENTION

1. Field of the Invention

The present invention relates generally to client-server systems and more specifically to a method and apparatus for generating an operational processing load, e.g. in a client server system.

2. Description of Related Art

Computing devices are increasingly used in a steadily growing number of fields. For example, applications executing on computing devices generally provide services in office environments, for example for text processing applications, spreadsheet applications, communication applications, accounting applications, scientific applications and similar. Moreover, computing devices are increasingly employed for providing services in private environments, for example, text processing applications, organizers, purchasing transactions, banking transactions, communication applications, entertainment applications and similar. Further, with the continuously increasing processing capabilities of computing devices and the increased proliferation of computers in offices and homes, computer applications are becoming increasingly versatile and complex.

Moreover, conventionally application programs e.g. for one of the services described above, were installed on a stand-alone computing device, such as a desktop computer, and received inputs from local input devices such as a keyboard and mouse, floppy disk, CD ROM, etc. These application programs provided a local output, e.g. to a screen, or were used to store generated or modified data files.

As opposed thereto, computing devices are now increasingly interconnected via computer networks, allowing an exchange of data between different computing devices. For example, a service application may not only reside on a single data processing device, but also may be distributed over a plurality of data processing devices, the execution of the application being controlled via the computer network. Further, different applications, e.g. for providing one of the services described above, may exchange information regarding the provided service or user.

For example, one of the services described above was provided in a client-server environment, where a service application resided on a server unit. A user operating a client unit controlled the service application. The user transmitted commands for controlling the application via a computer network to the server unit. In this case, the main portion of the service application was located at the server unit, e.g. a part of the service application requiring large resources, while only little more than an access and control portion of the service application was provided at the client unit.

Accordingly, resources at the client unit were saved, which was particularly important in case small client devices were used, such as palmtop computers, personal digital assistants, mobile phones, etc.

Further, installing the main portion of the service application at the server unit enabled a central maintenance of the service application and enabled use of the service application by a plurality of users, e.g. concurrently accessing the server unit from a plurality of client units.

The above technique was, for example, applied in office environments or private use environments to remotely provide any kind of service, such as text processing services, spreadsheet services, communication services, computer games or similar. To gain access to the service application, i.e. to obtain a desired service, a user established a communication session between a client unit and a server unit. The communication session was an active connection between the client unit and the server unit. The communication session was established over any kind of communication link, e.g. network connecting the client unit and the server unit or any kind of dedicated communication line, etc.

As the server enabled access to services for a plurality of users, the server was required to handle a plurality of communication sessions with a plurality of client units at the same time. Thus, a problem could occur in that a plurality of users was concurrently accessing a server unit or a plurality of server units, the requested computing resources exceeding the resources available at the server unit or plurality of server units. Accordingly, the service provided to the individual user was degraded or, in the worst case, the server unit denied any further service due to an overload situation.

Accordingly, it is important to obtain information on a behavior of the server unit or plurality of server units under an operational load condition, to be able to appropriately dimension or configure a server etc. Preferably, stress testing of a server under an operational load condition is performed during a test phase of an existing or new service application or applications, prior to releasing the service application or applications for use by subscribers.

As a straight forward approach for stress testing a server unit or units, a plurality of client units could be provided in the test phase, and each client unit could be used to establish a communication session with the server unit or units, and simulation software for simulating user behavior could be executed on each single client unit.

While this approach may be feasible for a small number of client units, i.e., a small number of client communication sessions, simulating a large number of client units, e.g. in the range of one hundred or several hundreds of client units, would require excessive time and resources.

### SUMMARY OF THE INVENTION

In one embodiment, a method and structure generate an operational processing load requiring decreased implementation efforts and costs. For example, a method for generating an operational processing load includes accessing, at a client unit, test input data for controlling at least one application; establishing a plurality of communication sessions involving the at least one application; and producing the test input using the test input data in association with each of the plurality of communication sessions. Accordingly, a client unit is used to establish and conduct a plurality of communication sessions, e.g. between the client unit and a server unit.

In a further embodiment user input operations input via a graphical user interface at the client unit are recorded. The user input operations, constituting test input, are used for controlling the at least one application at the server unit. Accordingly, user input operations, during a communication session, entered for controlling the application are recorded for later replay.

In a further embodiment, the recording includes recording time intervals between the individual user operations. Thus, information on a time sequence of user input operations is obtained to improve control of the replay operation.

The test input including, for example, the user input operations and timing data, is stored as test input data at the client unit and the test input data may be accessed within each of the plurality of communication sessions for replaying the test input data in each of the communication sessions to simulate user input. Accordingly, each communication session can individually retrieve and replay the test input data, e.g., as if the communication sessions were established involving a plurality of client units.

Each of the plurality of communication sessions involves an instance of the graphical user interface at the client unit, in one embodiment. Accordingly, each communication session may individually launch a graphical user interface to simulate more realistically a plurality of communication sessions.

Each of the plurality of communication sessions includes, in one embodiment, a thread in a process involving the at least one application at the server unit. Further, each of the plurality of communication sessions involves an instance of the at least one application at the server unit in this embodiment. This allows more realistic simulation of computational loads generated within each communication session, if a communication session involves an instance of the application or a thread in a process.

The test input is transmitted in each communication session to the at least one server unit, thus allowing each communication session to individually control the application. In a further embodiment the production of the test input is started in at least two communication sessions with a time offset. Further, each of the plurality of communication sessions is established based on statistical user behavior data. Moreover, the production of the test input in each communication session may be started based on statistical user behavior. Still further, the reproduction of the test input may involve modifying time intervals between the individual operations of the test input, and this may involve compressing or expanding the time intervals between the individual operations of the test input. Accordingly, realistic user behavior may be simulated.

In a further embodiment a program is provided having instructions adapted to cause data processing means to carry out at least one of the above operations. Further, a computer readable medium may be provided, in which a program is embodied, where the program is to make a computer execute at least one of the above operations. In a further embodiment a computer program product comprises the computer readable medium.

### BRIEF DESCRIPTION OF THE DRAWINGS

FIG. 1 illustrates a system for generating an operational processing load according to an embodiment of the invention.

FIG. 2 is a process flow diagram for a method for generating an operational processing load according to an embodiment of the invention.

FIG. 3 illustrates another system for generating an operational processing load according to another embodiment of the invention.

FIG. 4 is a process flow diagram for a method for generating an operational processing load according to an embodiment of the invention, particularly operations for recording user input.

FIG. 5 is a process flow diagram for a method for generating an operational processing load according to an embodiment of the invention, particularly a replay of test input within a plurality of communication sessions.

FIG. 6 is a process flow diagram for a method for generating an operational processing load according to an embodiment of the invention, particularly operations for replaying test input in a plurality of communication sessions.

FIG. 7 is a process flow diagram for a method for generating an operational processing load according to an embodiment of the invention, particularly operations in connections with simulating user behavior.

FIG. 8 shows elements of a system for generating an operational processing load according to an embodiment of the invention.

### DETAILED DESCRIPTION

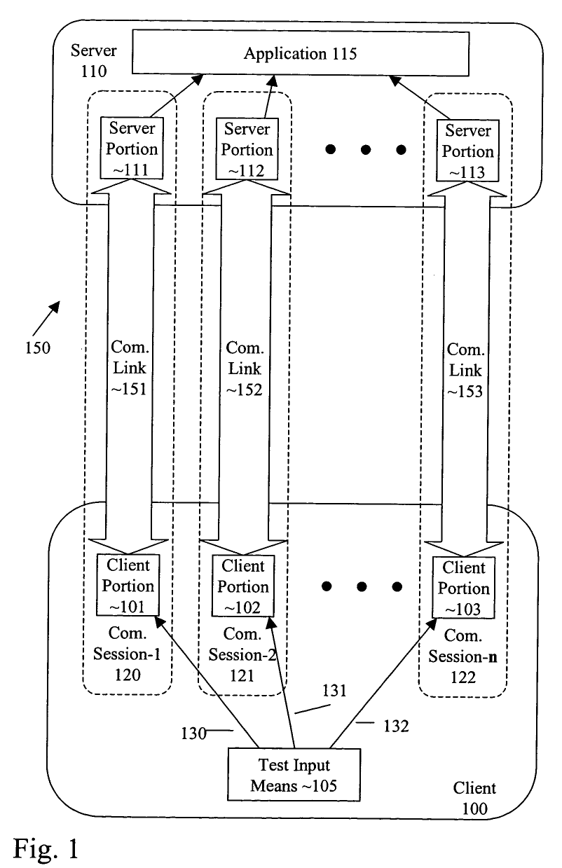

In one embodiment, an operational processing load is generated for a server with decreased implementation efforts and costs compared to the prior art methods. As explained more completely below, at a client unit 100 (FIG. 1), test input data for controlling at least one application 115 is accessed. A plurality of n communication sessions 120, 121, and 122 involving at least one application 115 are established between client unit 100 and server 110. The accessed test input data is used to produce the test input in association with each of the plurality of n communication sessions. Accordingly, in this embodiment, a single client unit is used to establish and conduct a plurality of communication sessions, e.g. between the client unit and a server unit.

The test input includes, for example, user input operations and timing data that is stored as test input data at client unit 100, in one embodiment. The timing data is used, for example, in determining when to start a user operation that results in a command being transmitted to server 110.

The test input data may be accessed within each of the plurality of n communication sessions for replaying the test input data in each of the communication sessions to simulate user input. Accordingly, each communication session can individually retrieve and replay the test input data, e.g., as if the communication sessions were established involving a plurality of client units.

Accordingly, it is no longer necessary to configure a large number of client units to generate a realistic operational load for a stress test of server 110. This facilitates testing of applications and server configurations prior to releasing the applications for use.

More particularly, FIG. 1 illustrates elements of a system 150 for generating an operational processing load according to an embodiment of the invention. System 150 includes a client 100, a server 110, and a plurality of n communication sessions established between client 100 and server 110. While FIG. 1 shows only a first communication session 120, a second communication session 121, and the nth communication session 122, it is understood that these three communication sessions are representative of establishment of an arbitrary number n of communication sessions.

Further, server 110 includes an application 115, which may be any kind of application that remotely provides a service for a user operated client unit 100, sometimes called client 100. For example, application 115 is controlled through commands transmitted from client 100 to server 110 in association with each of communication sessions 120, 121 and 122. Application 115 may be any kind of service application for providing services to a plurality of users, e.g. a text processing application, a spreadsheet application, a banking application, a communication application, an entertainment application or any other similar application.

Client 100 also includes a test input means 105 (i) for accessing test input data for controlling application 115, and (ii) for producing test input from the test input data in association with each of the plurality of n communication sessions 120, 121 and 122. Producing the test input includes playing or replaying the accessed test input data. In further examples, the test input data may be constituted by pre-recorded user input operations or by simulated user input operations.

The plurality of n communication sessions 120 to 122 can be established over any kind of communication link or links connecting client 100 and server 110. For example, communication links include a local area or wide area computer network, dedicated communication lines etc. In the present example, plurality of n communication sessions 120, 121 and 122 are established through a plurality of n communication links 151, 152 and 153, respectively.

By establishing a plurality of n communication sessions for controlling application 115 and by producing test input in association with each of the plurality of n communication sessions, an operational load is generated for server 110. This operational load is used as a stress test of server 110. For example, performance, stability of the application or other programs, and/or latency between input of commands and service is monitored. Based on the results of the monitoring, server 110 or application 115 is appropriately modified to improve the provided service.

According to an example, each of the plurality of n communication sessions includes a communication session server portion at server 110 and a communication session client portion at client 100. More precisely, communication session 120 involves a client portion 101 and a server portion 111; communication session 121 involves a client portion 102 and a server portion 112; and communication session 122 involves a client portion 103 and a server portion 113.

Client portions 101, 102 and 103 of communication sessions 120 to 122 are programs or program modules that upon execution establish and maintain each respective communication session client portion, e.g. transmit commands from client 100 to server 110 for controlling application 115 and receive, for example, display processing results from server 110. More precisely, a plurality of n client portions 101 to 103 of the plurality of n communication sessions 120 to 122, respectively, are constituted by coded instructions executed on a central processing means at client 100 to establish a client portion for each of the plurality of n communication sessions 120 to 122 involving application 115 at server 110. Alternatively or in addition thereto, the plurality of n client portions 101 to 103 also include hardware components.

Similarly, the plurality of n communication sessions 120, 121 and 122 include a plurality of n communication session server portions 111, 112 and 113, respectively. Server portions 111, 112 and 113 are similar to client portions 101, 102 and 103, and are, in one embodiment, programs or program modules that upon execution establish and maintain the respective communication session portions, e.g. to receive commands from client 100 to server 110 for controlling application 115, and to return processing results to client 100.

System 150 (FIG. 1) allows establishment of a plurality of n communication sessions involving at least one application 115 at server 110, and to affect a replay of the test input from test input means 105 in association with each of the plurality of n communication sessions 120, 121 and 122. In operation, the test input from test input means 105 is provided to each of the plurality of n communication sessions 120, 121 and 122.

In an example, user input operations from test input means 105 are provided to each of the plurality of n client portions 101, 102 and 103 of the plurality of n communication sessions 120, 121, 122, respectively, as illustrated by arrows 130, 131 and 132. The received user input operations are transmitted from the plurality of n client portions 101, 102, and 103 to the plurality of n server portions 111, 112 and 113 of the plurality of n communication sessions 120, 121 and 122, respectively, to control at least one application 115 at server 110. The user input operations may originate from a single user or a plurality of users.

System 150 allows simulation of a plurality of realistic communication sessions between a client and a server. This eliminates the need to install and operate a plurality of client units, one for each communication session. Further, the embodiment of FIG. 1 allows reproduction of the test input operations within each of the communication sessions, thus realistically simulating a plurality of users controlling the application at the server. As the test input is reproduced in each of the plurality of independent communication sessions, a plurality of users and thus realistic operational load conditions are simulated. The operational behavior of the server is monitored and appropriately adapted, before the application or applications are released for subscriber use.

In the following, examples of the elements shown in FIG. 1 are described in further detail. The following examples show optional or alternative features of this embodiment of the invention and should not be construed as limiting the invention to the specific examples presented.

Client 100 may be any computing device such as a general-purpose computer. Alternatively, to be able to simulate a larger number of users, i.e., to establish a larger number of communication sessions with server 110, a data processing device having increased capacity, e.g. data storage and processing capabilities, is used. Also, a plurality of data processing devices, each having a plurality of communication sessions, may be combined to form client 100 to increase still further the number of communication sessions, which can be established with server 110.

Client 100 includes a central processing unit (not shown) and a memory (not shown). The memory stores data and program instructions to realize the functionality of this embodiment of the invention. For example, the central processing unit executes the program instructions to establish the plurality of n communication sessions 120, 121, and 122 involving at least one application 115 at server 110, and replays the test input in association with each one of the plurality of n communication sessions 120, 121, and 122. Coded instructions and programs for this functionality are stored in the memory and are retrieved and executed by the central processing unit as required, as is known in the art. Alternatively or in addition thereto, at least some of the functionality of client 100 may be realized by hardware components.

The central processing unit may be adapted to receive, from test input means 105, the test input operations and to replay these test input operations in association with each of the plurality of n communication sessions 120, 121, and 122. For example, the test input operation could be intermediately stored in a memory of client 100, and accessed by the central processing unit in connection with each of communication sessions 120, 121, and 122.

Each of client portions 101, 102, 103 of the n communication sessions 120, 121, and 122 are a process or a plurality of processes running on the central processing unit. Alternatively, each of the n communication sessions 120, 121, and 122 could involve a thread in a process at the central processing unit, the process serving all n communication sessions 120, 121, and 122.

The plurality of n communication links 151, 152 and 153 established in connection with each of the plurality of n communication sessions 120, 121 and 122 are established via a communication network or at least one dedicated communication link. For transmitting information relevant to the communication sessions between the server and the client, any transmission scheme or protocol can be used.

The plurality of n communication sessions 120, 121 and 122, established between client 100 and server 110, each constitute an active connection between client 100 and server 110, established based on an instruction for a communication session received or generated at client 100. Each of the plurality of n client portions 101, 102 and 103 and each of the plurality of n server portions 111, 112 and 113 are constituted by processes or threads executed at client 100 and server 110, respectively.

Communication between the plurality of n client portions and the plurality of n server portions of the plurality of n communication sessions are established by any suitable means, for example through the exchange of communication data packets over a packet switched network, such as the Internet, a local area network or similar. Alternatively or further thereto, communications between the client portion and the server portion within a communication session may be established through at least one dedicated communication link, such as a telephone connection including a wireless connection. In one embodiment, the plurality of n communication links 151, 152 and 153 are independent from one another to more realistically simulate individual users, e.g., a session ID and communication bandwidth is allocated individually for each of the plurality of n communication sessions. Nevertheless, the communication sessions may employ the same communication medium and may even employ one and the same carrier or channel.

Test input means 105, in one embodiment, is part of client 100, as shown in the embodiment of FIG. 1. Test input means 105 is arranged for accessing test input data and for producing the test input in each of the plurality of n communication sessions. Producing the test input includes playing or replaying the test input data. In another example, test input means 105 also records user input operations for controlling at least one application 115 at server 110. The functionality of test input means 105 may be realized using the central processing unit of client 100 or by a further processing unit, including further dedicated hardware components.

The test input data can be accessed and retrieved by test input means 105 from any source such as a memory storing pre-recorded user input operations or a test input source supplying simulated test input. In an example, during operation, test input means 105 accesses test input operations, e.g. as stored in a memory of client 100 or at an external location, to produce the test input to each of the plurality of n communication sessions.

In another example, test input means 105 is arranged to record user input operations, as they occur during an exemplary communication session conducted between client 100 and server 110, for controlling at least one application 115. For example, test input means 105 is arranged to record user input operations in a graphical user interface (GUI) at client 100, as input by a real user or by a testing operator for controlling at least application 115 at server 110.

A graphical user interface (GUI) is a graphics-based user interface that incorporates, for example, icons, pull-down menus and a mouse for entering commands, receiving processing results, displaying information etc. The GUI has become the standard way users interact with a computer or program implemented thereon.

The recorded user input data constitute test input operations for controlling at least one application 115 at server 110. Alternatively, user input operations for controlling a plurality of applications at server 110 may be recorded. Moreover, in another example, user input operations from a plurality of users are recorded.

Test input means 105 may be realized as an integral part of client 100, or may be realized at an external location. If test input means 105 is arranged at an external location, test input means 105 transmits the recorded user operations to client 100 via a communication network, a dedicated communication link, etc.

Further, a recording portion of test input means 105 may be provided at an arbitrary location to perform an offline recording of user input operations in a communication session for controlling at least one application 115. For example, the user input operations are recorded at a remote location, and information regarding the recorded user input operations are transferred to test input means 105 for the playback operation of the test input operations in the communication sessions. A transfer of the information regarding the recorded user input operations is accomplished through transfer of data over a communication network, via a floppy disc, via a CD-ROM, etc.

Still further, as an alternative to recording user input operations, test input means 105 is arranged to generate a sequence of user input operations, e.g. by random selection from a list of possible user input operations. Thus, test input means 105, in this embodiment, is arranged to generate simulated sequences of user input operations for each of the plurality of n communication sessions.

Server 110 is generally any kind of computing device. However, server 110, in one embodiment, is a computing device having sufficient capacity to accommodate accesses from a plurality of users involved in a plurality of communication sessions.

Even though in FIG. 1, a single server unit is shown, in an alternate example, server 110 is a plurality of interconnected server units. For example server 110 is a cluster of servers at one location or distributed over different locations and connected over a communication link.

Server 110 includes at least one central processing unit for establishing the plurality of n communication sessions. Each of the server portions of the plurality of n communication sessions, i.e. server portions 110, 112 and 113, is an individual communication session process, or may be constituted by threads of a single process for all communication sessions. The characteristics of the communication sessions at server 110 depend on the specific implementation chosen.

Server 110 includes an application 115 for providing any kind of service, such as described above. In one embodiment, application 115 provides a service to a plurality of users. Application 115 at server 110 may be any kind of service application for providing services to a plurality of users, e.g. a text processing application, a spreadsheet application, a banking application, a communication application, an entertainment application or any other similar application.

Application 115 is controlled through each one of the plurality of n communication sessions 120, 121 and 122. For example, in the case of a text processing application, each user may control a private set of text documents, e.g. physically stored at the server, or stored at the respective client. For example, text documents could be generated, manipulated or retrieved in association with each particular (simulated) user. During operation, user input operations constituting test input for controlling the text processing application could be reproduced in each of the communication sessions, i.e., commands could be transmitted from client 100 to server 110 within each of the communication sessions, instructing retrieval, modification or generation of text files.

Alternatively, in another example, instead of a single application, a plurality of applications is provided. The plurality of applications, e.g. applications of an office productivity suite, is controlled through each of the plurality of n communication sessions 120, 121 and 122. Application 115 can also be a single application program having a plurality of modules, e.g. modules located on different server units and cooperating to provide a particular user service.

Further, in another example, server 110 includes a monitoring unit for monitoring the operational load behavior generated by the plurality of n communication sessions 120, 121, and 122. The monitoring unit may be used to monitor performance of server 110 in the presence of a plurality of user access operations occurring in connection with the plurality of communication sessions; to monitor the stability of the execution of application program 115; or to monitor a latency of responses to user commands, e.g. to assess a performance of the application as perceived by a user. The monitoring unit also may be at a location external to server 110.

In one embodiment, a program or programs have instructions adapted to cause a data processing device or a network of data processing devices to realize elements of the above embodiments and adapted to carry out the method of at least one of the above operations. Further, a computer readable medium may be provided, in which a program is embodied, where upon execution of the program by a computer, the method of the above operation results.

Also, a computer-readable medium may be provided having a program embodied thereon, where the program is to make a computer or a system of data processing devices to execute functions or operations of the features and elements of the above-described examples. A computer-readable medium can be a magnetic or optical or other tangible medium on which a program is recorded, but can also be a signal, e.g. analog or digital, electronic, magnetic or optical, in which the program is embodied for transmission. The computer-readable medium may constitute a data stream embodying the program. Further, the computer-readable medium may constitute a data structure embodying the program. Still further, a computer program product may be provided comprising the computer-readable medium.

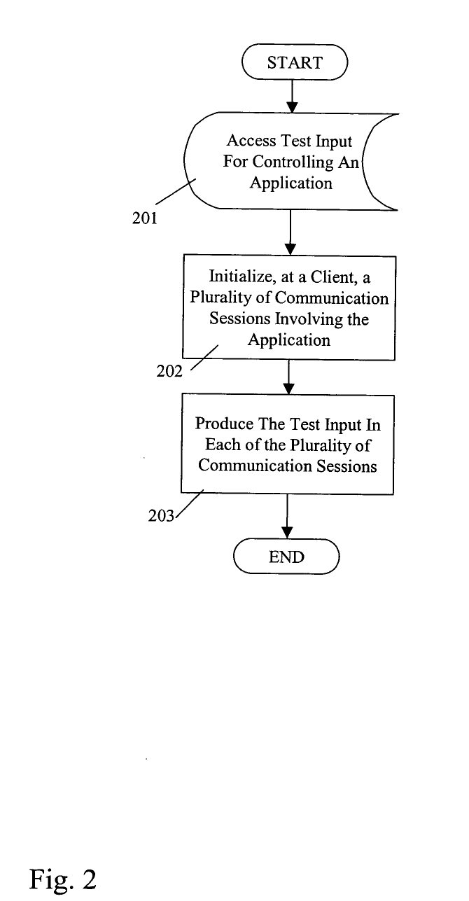

FIG. 2 shows a process flow diagram for a method for generating an operational processing load at a server according to an embodiment of the invention. The operations of FIG. 2 may be executed using the system shown in FIG. 1. However, the operations in FIG. 2 are not limited thereto.

The embodiment of FIG. 2 includes providing a plurality of communication sessions between a client and a server to concurrently simulate a plurality of communication sessions involving users controlling an application at the server. A single client unit or a plurality of client units may be provided for establishing the plurality of communication sessions with one server unit or a plurality of server units.

In a first operation 201, test input data for controlling an application is accessed. As described before, the test input data may be pre-recorded user input operations that was recorded during an actual user communication session involving the application, or, the test input data could be constituted by a sequence of, for example, randomly, or according to a certain rule, selected user input commands from a list of possible user input commands. The test input data may be available locally at a client, such as client 100 of FIG. 1, or may be retrieved from an external location, e.g. via a communication link, from a floppy disc, or CD ROM etc.

In an example, the test input data includes a plurality of user commands, e.g. as input in a graphical user interface when controlling an application at a server, such as a text processing application or similar. Further, in another example, the test input data includes a time sequence of events generated based upon user input commands, as received through a graphical user interface. Upon completion, operation 201 transfers processing to operation 202.

In an operation 202, a plurality of communication sessions is initialized, each of the plurality of communication sessions involving the execution of the application at the server, such as application 115 and server 110. In an example, the plurality of communication sessions is established by means for repeatedly executing a program for initializing a communication session and for assigning, at the client, a client communication session ID to each initialized communication session. The client communication session IDs facilitate distinguishing between the individual communication sessions, e.g. by the test input means when replaying the recorded input operations within each communication session. Parallel thereto the server may allocate a server communication session ID to each communication session. The server communication session ID and the client communication session ID of a communication session need not coincide.

While operation 202 in the present embodiment is performed after operation 201, in an alternative embodiment, operation 202 may be performed before operation 201.

In an operation 203, the test input is produced based upon the test input data, i.e. played, replayed or supplied, in each of the plurality of communication sessions, e.g. by test input means 105 of FIG. 1. Replaying the test input may involve providing, e.g. from test input means 105 to client portions of the communication sessions, a sequence of events or instructions for transmission to the server to control the application at the server.

In an example replaying the test input in each individual of the communication sessions is started at varying points in time and can further be varied based on statistical user data to more realistically simulate user operations. In the present embodiments, it is no longer necessary to set up a plurality of client units including the required simulation programs, each one for simulating a user accessing the application at the server.

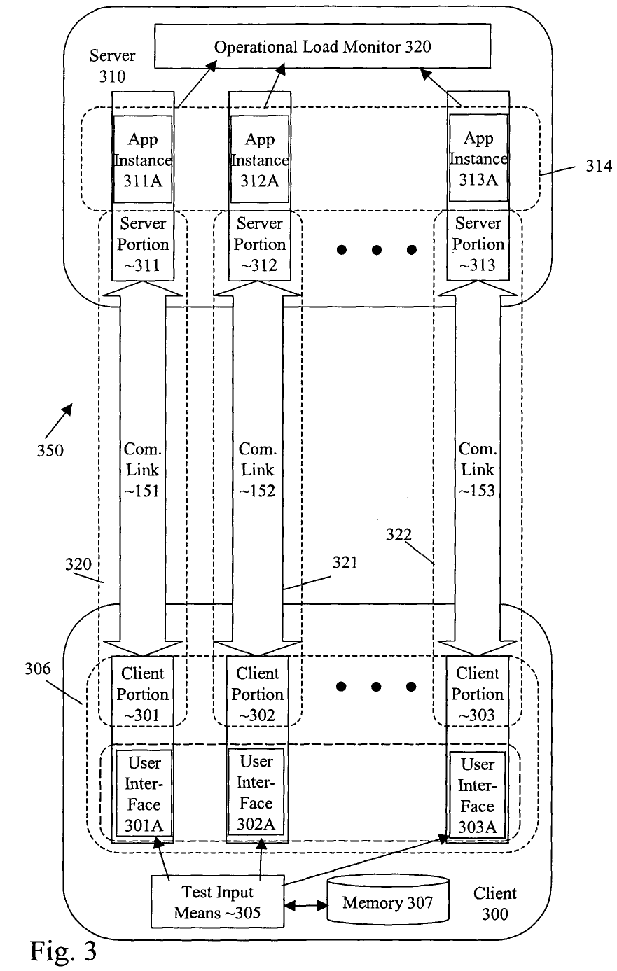

FIG. 3 shows elements of a system 350 for generating an operational processing load according to another embodiment of the invention. A client 300 has a configuration similar to client 100 (FIG. 1) that was described above. A server 310 has a configuration similar to server 110, as described above. A plurality of n communication sessions is established between client 300 and server 310 including a plurality of n client portions 301, 302, and 303 at client 300 and a plurality of n server portions 311, 312 and 313 of the communication sessions at server 310 with similar configurations as the respective client and server portions shown in FIG. 1. The communication sessions use communication links 150, 151 and 152 and may be established and maintained as it was described with respect to FIG. 1.

Further, client 300 includes test input means 305, and includes a memory 307 for storing test input operations, program code and similar information. Client 300 also includes a plurality of user interfaces 301A, 302A and 303A, each one in association with a different one of the plurality of n communication sessions 321, 322, and 323 between client 300 and server 310.

Each of user interfaces 301A, 302A and 303A are arranged to receive user input operations from test input means 305, and to simulate user behavior occurring in association with the corresponding communication session. For example, user interfaces 301A, 302A and 303A may be constituted by modified graphical user interfaces, suited to be operated by a user and/or test input means 305, to control the execution of an application at server 310.

In another example, user interfaces 301A, 302A and 303A are realized by individual processes executed by a central processing unit 306 of client unit 300, each process associated with an individual one of the communication sessions. Alternatively, in another example, user interfaces 301A, 302A, and 303A are constituted by threads of a process for executing code instructions associated with a modified graphical user interface, each of the threads being associated with one of the plurality of n communication sessions.

Similar to the embodiment described above with respect to FIG. 1, test input means 305 may be adapted to replay test input operations in association with each of the plurality of n communication sessions. In this connection, test input means 305 retrieves and supplies a sequence of user input operations constituting test input or a sequence of events based thereon to each of user interfaces 301A, 302A and 303A, instructing user interfaces 301A, 302A, and 303A to transmit the user input operations or associated commands or instructions to server 310.

In an example, test input means 305 is adapted to record user input operations of a “real” communication session involving a user controlling the at least one application at server 310. To be able more accurately replay the test input operations, test input means 305 is adapted to record time intervals between the individual user input operations. Thus, the actual user behavior including time spans between individual user input operations may be simulated.

For example, if the application program is constituted by a text processing application, the user input operations may relate to instructions for retrieving, editing, or generating text documents, including displaying portions of the text document at client unit 300, scrolling through documents, saving operations, data transfer operations and similar. Then, during the playback operation of the test input operations within each of the communication sessions, the exact time sequence and time interval between the user input operations may be reproduced to more accurately simulate the user behavior.

Still further, test input means 305 may be adapted to store the test input as test input data and to access the test input data in association with each of the plurality of n communication sessions for replaying the test input data in each of the plurality of n communication sessions for simulating the user input. Thus, the user input operations, i.e. the test input may be reproduced individually and independently within each of the communication sessions to simulate more accurately the behavior of individual users.

The functionality of test input means 305 may be realized using a central processing unit of client 300 or by another internal or external device.

In a further example, test input means 305 or alternatively the central processing unit of client 300 is adapted to start the reproduction of the test input in at least two of the communication sessions with a time offset. Accordingly, more natural user behavior is simulated, as also in a real world scenario users establish and conduct a communication session at different points in time. Time shifting of the reproduction of the test input avoids the unrealistic occurrence of one and the same user input operation of the test input at the same time within each communication session.

Alternatively or further thereto, test input means 305 and/or a central processing unit of client 300 may be adapted to establish each of the plurality of communication sessions based on statistical user behavior data. Thus, a processing load in connection with establishing a communication session between a client computer and the server is distributed as in a practical environment.

For example, test input means 305 may be adapted to monitor the behavior of a plurality of real users including time stamps of initialization of communication sessions and control operations for individual users. Accordingly, communication sessions may be simulated as in a real world scenario, and the reproduction of the test input operations may also be executed as in a real world environment. Thus, the reproduction of the test input operations in each of the communication sessions may be started based on statistical user behavior data.

Further, in another example, instead of user input operations recorded in association with a single communication session involving a single user, user input operations occurring in connection with a plurality of communication sessions involving a plurality of users are individually recorded and used for the operational load generation.

Still further, test input means 305 or the central processing unit of client 300 may be adapted to replay the test input data with modified time intervals between the individual user input operations, e.g., modified by compressing or expanding the time intervals between the individual user input operations. Accordingly, time aspects of user behavior may be considered, e.g. users generating a “slow” sequence of input commands versus users generating a “fast” sequence of user input operations.

The embodiment of FIG. 3 further illustrates an application 314 at server 310, controlled in association with each of the communication sessions. Application 314 may be constituted by a single application, such as a text processing application, or may be constituted by a plurality of applications, such as a group of applications of an office productivity suite or similar.

Further, in another example, an instance of application 314 is launched in association with each one of the communication sessions, shown as instances of the application 311A, 312A and 313A. An instance of application 314 is, for example, a process started at server 310 for executing application 314. Thus, an instance may be a single copy of a running program, i.e. the application, and multiple instances of the application mean that the application has been loaded into memory several times.

Alternatively, threads of a process associated with the application may be maintained in association with each one of the communication sessions. The decision whether to use a process or a thread in a process association with the application may depend on a selected installation of the application.

Still further, server 310 includes an operational load monitor 320 for monitoring the operational load behavior of server 310 in the presence of the plurality of n communication sessions and multiple reproduction of the recorded or generated user input operations. The monitoring operations involve at least one of monitoring a processing load at server 310 and monitoring a stability of the execution of the application or programs associated with establishing and maintaining the individual communication session at server 310, and similar.

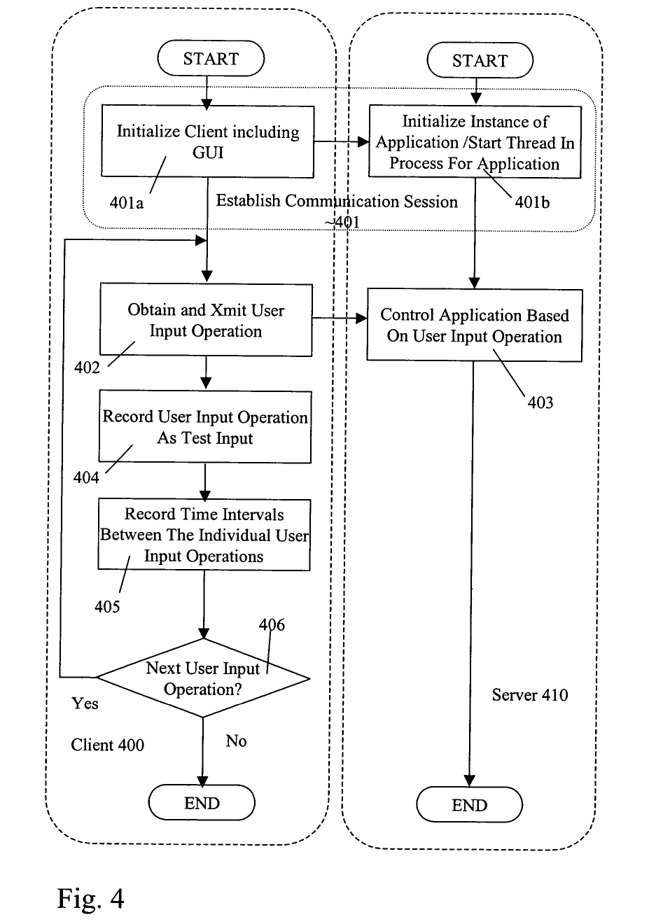

FIG. 4 is one embodiment of a process flow diagram for a method for obtaining a set of user input operations for later replay in each of a plurality of communication sessions in another embodiment of the invention. The operations of FIG. 4 are executed. by system 150 (FIG. 1) or system 350 (FIG. 3) in one embodiment.

In a first operation 401, a communication session between client 400, e.g. client 100 (FIG. 1) or client 300 (FIG. 3), and server 410, e.g. server 110 (FIG. 1) or server 310 (FIG. 3), is established. In one embodiment, the communication session has a unique communication session ID, allowing server 410 and client 400 to identify any commands, events etc., occurring in association with the communication session.

Operation 401 includes a client initialization operation 401a at client 400, e.g. including the initialization of a graphical user interface at client 400 in association with the current communication session. In another example, the graphical user interface involves a graphical user interface program for presenting a graphical display on a display means associated with client 400 to enable a user to input commands for controlling the progress of the communication session between the client and the server.

Further, in an operation 401b at server 410, the server part of the communication session between client 400 and server 410 is initialized, i.e., server 410 is prepared to receive instructions from the user through client 400. Further, at least one service application program is started at server 400, e.g. a text processing program, or programs of an office productivity suite, e.g. including communication programs, spreadsheet programs etc. At least one application program, sometimes called application, is started based on at least one user command, e.g. generated based upon a selection or input of a corresponding command through the graphical user interface at client 400.

In another example, starting the at least one application at server 410 involves initializing an instance for the at least one application at server 410, i.e., to start a process for the at least application program that executes the at least one application. The application program may be stored in a memory associated with server 410 and may be loaded, e.g., into a random access memory of server 410, for execution.

In an alternative example, an application program is started by allocating a thread in a process executing the application program to the communication session, i.e., to a particular user. In this case a single process may be present for executing the application program at server 410 including threads, each threads allocated to a particular user. Upon completion, operation 401a transfers processing to operation 402.

In an operation 402, a user input operation is obtained and transmitted to server 410. In one embodiment, the user input operation is input using the graphical user interface, and involves any command for controlling the communication session with the at least one application at server 410. For example, if the at least one application at server 410 involves a text processing application, the user input operation could involve a command regarding retrieval, modification and similar of a text document, could involve a command related to scanning through a document, saving a document, transferring a document and similar. Upon completion, operation 402 transfers processing to operation 404.

In operation 403, the at least one application at server 410 is controlled based on the user input operation received from operation 402. In correspondence to the user input command, this could e.g. include retrieving a document and transferring data related to the document to client 400 for local display at client 400, etc.

In operation 404, the user input operation of operation 402 is recorded, e.g. using test input means 105 (FIG. 1) or test input means 305 (FIG. 3). Recording the user input operation may include detecting a user input command, e.g. a command as input in the graphical user interface, and storing an identification of the user input command, or may include detecting and storing events generated at client 400 based on the user input command. The user input operation may be recorded as test input data, e.g. in a file stored at client 400. Upon completion, operation 404 transfers processing to operation 405.

In operation 405, time intervals between the individual user inputs operations are recorded to obtain knowledge about the exact time sequence of operations executed for controlling the communication session and/or the at least one application. Recording the time intervals, in one embodiment, involves recording time intervals of a sequence of events generated at client 400 in association with user input commands for controlling the communication with and/or the at least one application at server 410. Also, a time stamp of initialization of the communication session between the client and the server is recorded optionally. Upon completion, operation 405 transfers processing to operation 406.

In a check operation 406, it is determined whether a next user input operation is present, and, if the decision is YES, the flow of operations returns to operation 402 for a subsequent recording cycle. If the decision in operation 406 is NO, i.e., if a next user input operation is not input, the operations end.

The above embodiment describes an example of recording a communication session as conducted by a user to allow a later reproduction of the same communication session for testing purposes. The above communication session may be an exemplary communication session, conducted by a testing operator. However, the communication session may also be recorded in a real environment, e.g., a user behavior of a subscriber of services could be monitored.

To obtain further knowledge about user behavior, a plurality of users may be monitored as described above, to record a plurality of different communication sessions for later reproduction in an operational load stress testing operation.

Further to the above information about the user communication session, information about a time of day of commencing the communication session, and further statistical user behavior may be recorded. For example, access frequencies of users could be recorded, type and number of applications started could be recorded, resources used etc. Alternatively, a possible sequence of user input operations for a later reproduction in an operational load testing operation could be generated by selecting user input operations from a list of possible user input operations according to a particular rule.

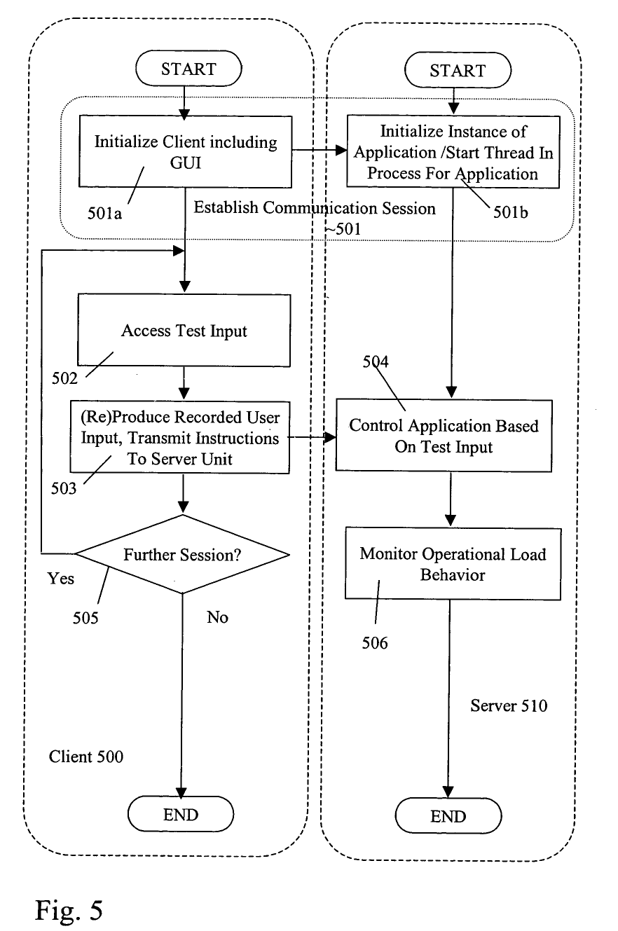

FIG. 5 is a process flow diagram for a method for generating an operational load according to another embodiment of the invention. The operations of FIG. 5 may be executed by system 150 (FIG. 1) or system 350 (FIG. 3), but the operations in FIG. 5 are not limited thereto. FIG. 5 particularly outlines operations in connection with reproducing test input operations in a plurality of communication sessions.

In a first operation 501, a communication session between client 500, e.g. client 100 (FIG. 1) or client 300 (FIG. 3), and server 510, e.g. server 110 (FIG. 1) or server 310 (FIG. 3), is established. In one embodiment, the communication session has a unique communication session ID, allowing server 510 and client 500 to identify any commands, events etc., occurring in association with the communication session.

Operation 501 includes an operation 501a at client 500 to initialize a graphical user interface associated with the communication session and further includes an operation 501b to start at least one application at server 510, which may involve initializing an instance of the application or allocating a thread in a process for the application associated with the communication session. The communication session has a communication session ID to distinguish this communication session from other communication sessions. Operations 501, including operations 501a and 501b in association with establishing the communication session and starting the application program, may be similar to operation 401 including operations 401a and 401b of FIG. 4.

Further to the operations of FIG. 4, establishing the communication session may involve initializing a modified user interface at client 500, e.g. modified graphical user interface, adapted to receive user input operations not directly from a user, but from a test input means, such as test input means 105 (FIG. 1) or test input means 305 (FIG. 3). The test input means replays the test input. Operation 501a transfers processing to an operation 502.

In access test input operation 502, test input data is retrieved by the test input means, e.g. by test input means 105 or test input means 305. The test input means may retrieve test input data as, e.g., recorded user input operations using the method of FIG. 4. The user input operations may be retrieved from a locally stored test input file, or may be retrieved from a remote location, as described above. Operation 502 transfers processing to an operation 503.

In operation 503, the test input means produces the test input as obtained in operation 502, and transmits corresponding instructions to server 510. Producing the test input may include a playback operation of test input or any other operation to supply test input to server 510. Operation 503 transfers processing to a check operation 505.

Server 510, in operation 504, controls the at least one application based on the user input operations replayed at client 500 in association with the current communication session. Server 510 may not even be “aware” that the current communication session is not a “real” communication session but a replayed communication session for stress testing purposes.

Controlling the application based on the user input operations at server 510 may involve any of the operations described above, e.g. modification, retrieval and storing operations of documents in connection with a text processing application.

Operation 504 transfers processing to an operation 506. In operation 506, at server 510, the operational load behavior of the server is monitored, e.g. as known in the art.

In operation 505, it is determined whether a further communication session between client 500 and server 510 should be established. Operation 505 may take place during the ongoing replay of test input, as specified by operation 503.

If in operation 505, the decision is “YES”, i.e. if a further communication session should be established, the flow of operations returns to operation 501, and otherwise, the flow of operations ends. Accordingly, a plurality of communication sessions may be established between client 500 and server 510, the execution times of the communication sessions overlapping one another.

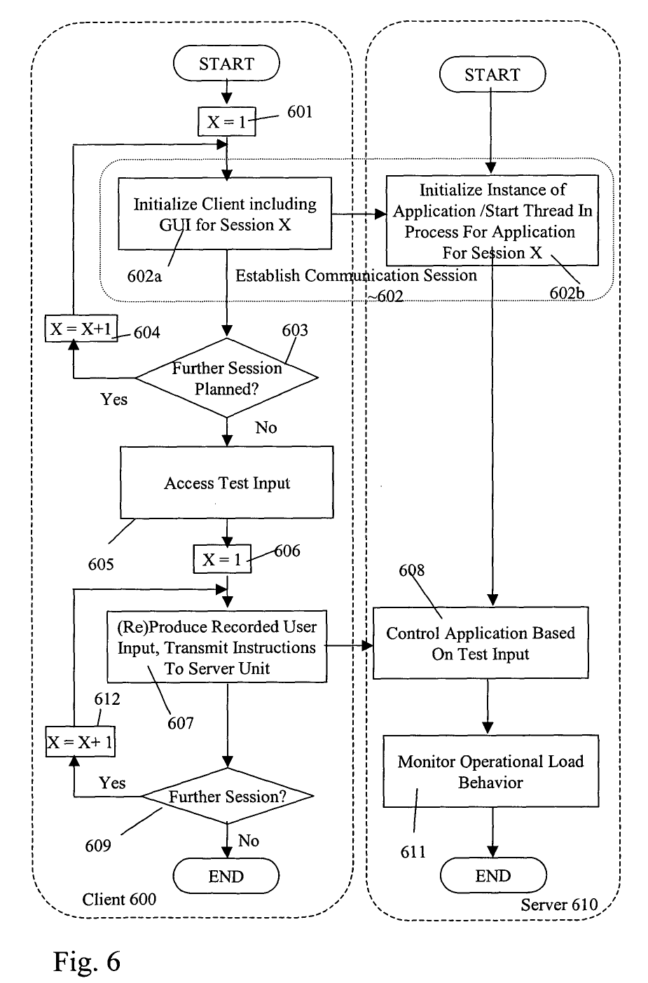

FIG. 6 shows operations of a method for generating an operational load at a server according to another embodiment of the invention, particularly showing operations for establishing and maintaining communication sessions for replaying test input. The operations of FIG. 6 may be executed by system 150 (FIG. 1) or system 350 (FIG. 3). However, the operations in FIG. 6 are not limited to execution by systems 150, 350.

In a first operation 601, a communication session counter is initialized to a predefined value by client 600, e.g. client 100 (FIG. 1) or client 300 (FIG. 3). In this embodiment, the communication session counter is initialized to a value of one. Operation 601 transfers processing to initialize client communication session operation 602a of establish communication session operation 602.

In operation 602a, client 600 initializes a user interface for a first communication session that has a communication session parameter associated with the current value of the communication counter. The graphical user interface is appropriately adapted to receive test input operations versus real user input commands. It is noted that it is not necessary that the graphical user interface is actually displayed on a display at client 600. Rather, in one embodiment, the graphical user interface is a process executed in the background.

In an operation 602b of operation 602, at least one application is started at server 610, e.g. server 110 (FIG. 1) or server 310 (FIG. 3). In one embodiment, starting the at least one application includes initializing an instance of the at least one application of server 610 or allocating a thread in a process for the at least one application with a communication session that has a communication session parameter associated with the current value of the communication counter. The elements of operation 602 may be similar to operation 401 (FIG. 4) and operation 501 (FIG. 5).

After establishing the first communication session in operation 602, operation 602a transfers processing to further session planned check operation 603. Check operation 603 determines whether a further communication session is planned, e.g., compares the value of the communication session counter with a maximum number of planned communication sessions. If a further communication session is planned, check operation 603 transfers processing to increment counter operation 604.

Operation 604 increments the communication session counter and transfers processing to operation 602a, which is repeated to establish another communication session, as described above and incorporated herein by reference. Upon completion, operation 602a transfers to check operation 603. Operations 603, 604 and 602 are repeated until the maximum number of planned communication sessions are established, and check operation 603 transfers processing to access test input operation 605.

Operation 605 accesses the test input data, e.g. by test input means 105 (FIG. 1) or test input means 305 (FIG. 3). The accessing can include retrieving test input data from any kind of test input source. The test input data may, e.g., be stored in a permanent file in random access memory of client 600 for facilitating a replay of pre-recorded input in each one of the communication sessions established in operations 601 to 604. Operation 605 transfers to a reset communication session counter operation 606.

In operation 606, the communication session counter is again initialized to the predefined value, e.g., a value of one. Operation 606 transfers processing to operation 607.

In operation 607, the (re)production of the test input is started in the first communication session, including transmitting instructions to server 610 for the at least one application. Operation 607 transfers processing to further session check operation 609. In an operation 608, at server 610, the at least one application, in communication session one, is controlled based on the received user input operations.

At client 600, in operation 609, it is determined whether a further communication session was established. If a further communication session was established, check operation 609 transfers processing to increment counter operation 612.

Operation 612 increments the communication session counter and transfers processing to operation 607, which is repeated for the next communication session, as described above and incorporated herein by reference. Specifically, operation 607 replays the test input. It is noted that the replay frequencies of the individual communication sessions, in one embodiment, overlap in time. Upon completion, operation 607 transfers to check operation 609.

Operations 609, 612 and 607 are repeated until operation 607 has transmitted instructions to server 610 for each of established communication sessions. When instructions have been transmitted to server 610 for each of the established communication sessions check operation 609 transfers to end operation. In an operation 611, the operation load behavior of server 610 is monitored as server 610 processes the various user instructions.

The example of FIG. 6 shows a case, where a plurality of communication sessions between client 600 and server 610 is first established, and then the test input is replayed to generate an operational load condition. While it is possible that the same test input is replayed in each one of the communication sessions, it is also possible that different sets of test input operations are replayed in individual ones of the communication sessions, e.g., as recorded in association with the embodiment described with respect to FIG. 4.

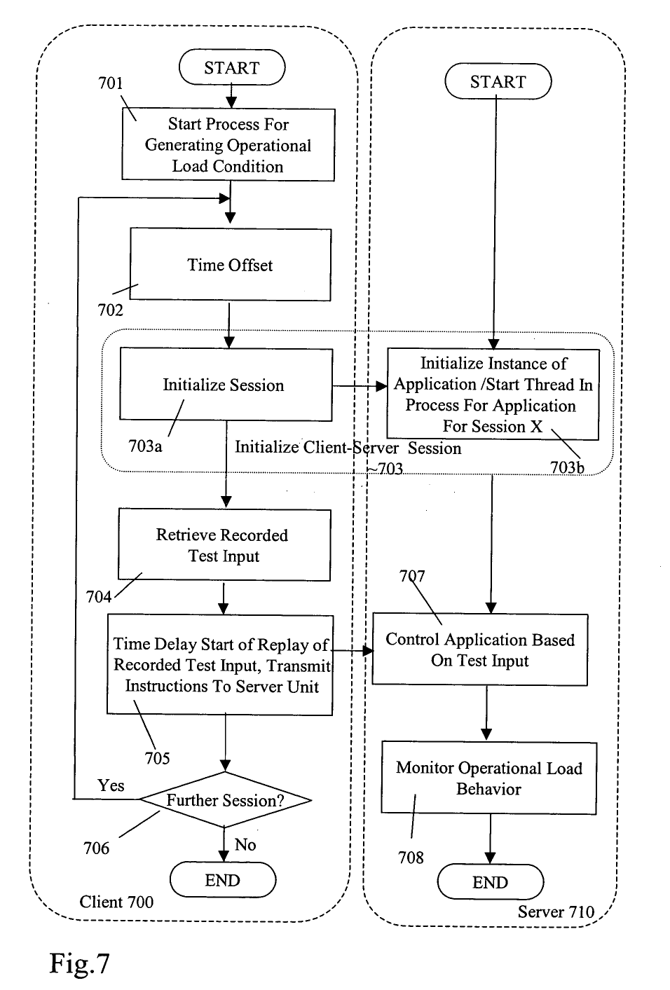

FIG. 7 shows a process flow diagram for generating an operational load according to another embodiment of the invention, particularly including operations for simulating a realistic user behavior in the process of generating an operational load. The operations of FIG. 7 may be executed by system 150 (FIG. 1) or system 350 (FIG. 3). However, the operations in FIG. 7 are not limited to execution by systems 150, 350.

In the present embodiment, prior to generating operational load conditions, information on user behavior was obtained, i.e. as described above for the process flow diagram of FIG. 4. For example, the times of operation, e.g. work or usage times of a plurality of individual users were obtained beforehand, e.g. by monitoring a plurality of “real” users accessing a server application.

In an operation 701, a process for generating an operational load condition at a server is started. In an example, the process involves, e.g., executing a program available at client 700, e.g. client 100 (FIG. 1) or client 300 (FIG. 3). The program includes instructions to make client 700 access test input data for controlling at least one application and instructions to establish a plurality of communication sessions involving the at least one application and to produce the test input in association with each of the plurality of communication sessions.

Upon completion, operation 701 transfers processing to a time offset operation 702. In operation 702, a time delay for a current communication session is determined to avoid launching a plurality of communication sessions all at the same time. For example, the time delay may be determined randomly or may be determined based on previously obtained user data. For example, statistical user behavior data, such as times of day of establishing a communication session, may be used. For example, individual start times of a plurality of “simulated” communication sessions may approximate “real” start times of a plurality of “real” communication sessions, as recorded beforehand.

Operation 702 transfers processing to an initialize client session operation 703a in an initialize client-server session operation 703. In operation 703, a current client server communication session between client 700 and server 710 is established based on the time of day obtained in operation 702. The operations carried out in operations 703a and 703b to establish the client communication session are equivalent to those described above with respect to FIGS. 4 to 6.

Operation 703a transfers processing to operation 704. In operation 704, recorded test input operations are retrieved in a manner equivalent to that described for the above embodiments. Upon completion, operation 704 transfers processing to operation 705.

In operation 705, the replay of test input operations is started with a timing or time delay modeling real user behavior. This timing or time delay may also be determined randomly or based on actual user behavior data. The test input operations are transmitted to operation 707 and in operation 707, an instance of at least one application is controlled using the test inputs.

In operation 705, the test input operations may be replayed in the current communication session at their original speed of occurrence, at a reduced speed or at an increased speed. The time intervals between the individual user input operations of the recorded set of user input operations may be compressed or extended. The corresponding sequence of events or instructions is then transmitted, upon occurrence, to server 710, to control the instance of the at least one application at server 710. Monitor operation load behavior 708 monitors the load on server 710.

Upon completion, operation 705 transfers processing to a further session check operation 706. At client 700, check operation 706 determines whether a further “simulated” communication session is to be established. If a further simulated communication session is to be established, check operation 706 transfers processing to time offset operation 702.

Operations 702, 703a, 704, and 705 are repeated in a manner equivalent to that described above. Upon completion, operation 705 again transfers to check operation 706. A desired number of simulated communication sessions may be preset, e.g. 10, 100, 1000, etc. Check operation 706 determines whether the desired number has been established.

Operations 702, 703a, 704, 705 and 706 are repeated until operation 706 determines that the desired number of simulated communication sessions has been established and then check operation 706 transfers to end operation to end the simulation.

While the operations the embodiments in FIGS. 4 to 7 are each shown in a specific sequence, it is also possible that another sequence of operations is established for further embodiments. Further, at least some of the operations of FIG. 7 may be optional and omitted in alternative embodiments. In addition, it is not necessary that the operations be performed sequentially.

It is noted that the individual communication sessions are established at least in a time overlapping manner, and the replay of the test input operations, either a single set of user input operations or a plurality of different sets of user input operations, also overlap in time. Thus, a realistic user behavior is simulated, and the operational load conditions are made more realistic.

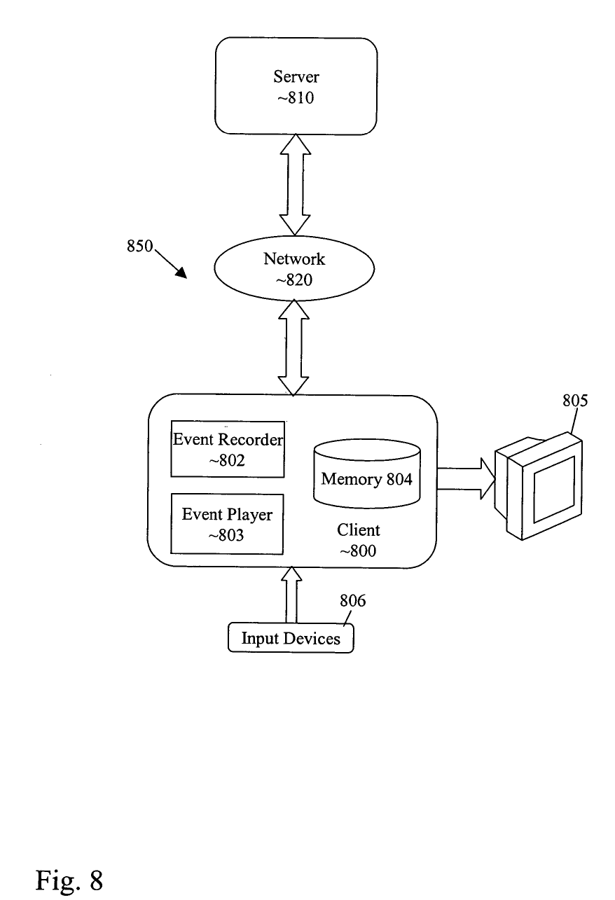

FIG. 8 shows elements of a system 850 for generating an operational load according to another embodiment of the invention. A client 800 includes an event recorder 802, an event player 803 and a memory 804. Client 800 has a similar constitution as client 100 (FIG. 1) and client 300 (FIG. 3).

Event recorder 802 records user input operations in an exemplary communication session, for later replay in a stress testing process. In one embodiment, event recorder 802 is an integral part of client 800. In another embodiment, event recorder 802 is at an external location, e.g. remote from client 800.

Event player 803 retrieves test input operations and replays the test input operations within a plurality of communication sessions, as described above. The functionality of event recorder 802 and/or event player 803 may be realized by a central processing unit of client unit 800 loading and executing appropriate programming code. Client 800 further includes a memory 804, e.g. for storing code instructions for realizing the functionality of client 800 and/or for storing the test input operations.

Further, a display 805 associated with client 800 facilitates the control of operations of client 800, including displaying a graphical user interface for recording user input operations and similar. Input devices 806, e.g. a keyboard and mouse device, are known in the art.

Client 800 is arranged to communicate with a server 810 through a network 820. Network 820 may be any kind of communication network, as known in the art, including a packet switched communication network such as the Internet or a local area network, a circuit switched communication network and similar. Further, the communication between the server and the client may be realized through dedicated communication links.

Server 810 is subject to a test under operational load conditions and has elements and functionality as described with regard to the previous embodiments.

During operation of system 850, client 800 is used to establish a plurality of communication sessions between client 800 and server 810. Each communication session has a communication session ID and is executed independent from other communication sessions.

Further, client 800, more precisely event player 803, is used to replay test input operations within each of the established communication sessions, to generate an operational load condition at server 810. The operational load behavior at server 810 is then monitored, e.g. regarding stability, latency, available resources, etc., to determine a quality of service.

The embodiment of FIG. 8 shows a single server 810. However, in an alternative embodiment, a plurality of servers may be provided for the test under operational load conditions. In this case, the communication sessions are established between client 800 and the plurality of servers substantially as described above. The communication sessions are allocated to individual ones of the plurality of servers using a load balancing mechanism, e.g. taking into account a processing load of individual ones of the plurality of servers, and similar.

In a further alternative, a plurality of servers and/or a plurality of clients are provided to establish a larger number of communication sessions, for further tests under operational load conditions. In this case it can be assured that the capabilities of the plurality of clients suffices to establish and maintain the plurality of communication sessions including replaying test input operations, without reaching client resource limitations.

It is noted that a program or programs may be provided having instructions adapted to cause a data processing device or a network of data processing devices to realize elements of the above embodiments and to carry out the method of at least one of the above operations. Further, a computer readable medium may be provided, in which a program is embodied, where the program is to make a computer execute the method of the above operation.

Also, a computer-readable medium may be provided having a program embodied thereon, where the program is to make a computer or a system of data processing devices execute functions or operations of the features and elements of the above-described examples.

A computer-readable medium includes a magnetic or optical or other tangible medium on which a program is recorded, but can also include a signal, e.g. analog or digital, electronic, magnetic or optical, in which the program is embodied for transmission. Further, a computer program product may be provided comprising the computer-readable medium having computer readable instructions embodied therein to perform any part of the methods described herein, any one of the methods described herein, or any combination of the methods described herein.

According to another embodiment of the invention, a client for generating an operational processing load at a server includes the following elements.

1) Client for generating an operational processing load at a server, including

a code section having instructions adapted to access test input for controlling at least one application; and

a code section having instructions adapted to establish a plurality of communication sessions involving the at least one application and to produce the test input in association with each of the plurality of communication sessions.

2) Client of 1), including a code section having instructions of a graphical user interface and including a code section having instructions adapted to record user input operations of the graphical user interface, the user input operations constituting test input for controlling the at least one application at a server.

3) Client of 1), including a code section having instructions adapted to record time intervals between the individual user input operations.

4). Client of 1), including a code section having instructions adapted to store the test input as test input data and a code section having instructions adapted to access the test input data within each of the plurality of communication sessions for replaying the test input data in each of the communication sessions to simulate user input.

5) Client of 1), including an instance of the graphical user interface for each of the plurality of communication sessions.

6) Client of 1), wherein each of the plurality of communication sessions includes a thread in a process at the server involving the at least one application.

7) Client of 1), wherein each of the plurality of communication sessions involves an instance of the at least one application at the server.

8) Client of 1), including a code section having instructions adapted to transmit the test input in each communication session to the server.

9) Client of 1), including a code section having instructions adapted to start the production of the test input in at least two communication sessions with a time offset.

10) Client of 1), including a code section having instructions adapted to establish each of the plurality of communication sessions based on statistical user behavior data.

11) Client of 1), including a code section having instructions adapted to start the production of the test input in a communication session based on statistical user behavior data.

12) Client of 11), including a code section having instructions adapted to produce the test input with modified time intervals between the individual operations of the test input.

13) Client of 12), wherein the modification includes compressing or expanding the time intervals between the individual operations of the test input.

While the present invention hereinbefore has been explained in connection with embodiments thereof, those skilled in the art will readily recognize that modifications can be made to these embodiments without departing from the spirit and scope of the present invention.

I claim:

1. A method for generating an operational processing load including:
accessing, at a client, test input data for controlling at least one application using the client;
establishing, at said client, a plurality of communication sessions involving the at least one application; and
producing, at said client, test input using said test input data in association with each of the plurality of communication sessions.

2. The method of claim 1, further comprising:
recording user input operations via a graphical user interface at the client, wherein the user input operations constitute the test input data for controlling the at least one application at a server.

3. The method of claim 2 where said recording user input operations further comprises:
recording time intervals between individual user input operations.

4. The method of claim 1 further comprising:
storing the test input as the test input data at the client prior to said accessing; and
replaying the test input in each of the communication sessions to simulate user input.

5. The method of claim 1, wherein each of the plurality of communication sessions involves a different instance of a graphical user interface at the client.

6. The method claim 1, wherein each of the plurality of communication sessions includes a thread in a process involving the at least one application.

7. The method of claim 1, wherein each of the plurality of communication sessions involves an instance of the at least one application at the server.

8. The method of claim 1 further comprising:
transmitting the test input in each communication session to a server.

9. The method of claim 1, wherein said establishing said plurality of communication sessions further comprises starting at least two communication sessions with a time offset.

10. The method of claim 1, wherein said establishing said plurality of communication sessions further comprises establishing each of the plurality of communication sessions based on statistical user behavior data.

11. The method of claim 1, wherein the producing the test input further comprises producing the test input based on statistical user behavior data.

12. The method of claim 3, wherein the producing the test input further comprises:
modifying time intervals in said time intervals between individual user input operations.

13. The method of claim 12, wherein said modifying includes compressing at least one time interval in said time intervals between individual user input operations.

14. The method of claim 12, wherein said modifying includes expanding at least one time interval in said time intervals between individual user input operations.

15. A computer readable medium, in which a computer-readable program is embodied, wherein execution of the computer-readable program results in a method comprising:
accessing, at a client, test input data for controlling at least one application using the client;
establishing, at said client, a plurality of communication sessions involving the at least one application; and
producing, at said client, test input using said test input data in association with each of the plurality of communication sessions.

16. The computer readable medium of claim 15 wherein the method further comprises:
recording user input operations via a graphical user interface at the client, wherein the user input operations constitute the test input data for controlling the at least one application at a server.

17. A device comprising:
a client unit for generating an operational processing load at a server, said client unit including:
processing means adapted to establish a plurality of communication sessions involving at least one application; and
test input means for accessing test input data for controlling the at least one application and for producing test input, using the test input data, in association with each of the plurality of communication sessions.

18. The device of claim 17, wherein said client unit further comprises:
a graphical user interface, wherein the test input means is adapted to record user input operations input via the graphical user interface and the user input operations comprise the test input data for controlling the at least one application at the server.

19. The device of claim 18, wherein the test input means is adapted to record time intervals between individual user input operations.

20. The device of claim 17, wherein the test input means is adapted to store the test input as test input data and to access the test input data within each of the plurality of communication sessions for replaying the test input data in each of the communication sessions to simulate user input.

21. The device of claim 17, further comprising:
an instance of a graphical user interface for each of the plurality of communication sessions.

22. The device of claim 17, wherein each of the plurality of communication sessions includes a thread in a process at the server involving the at least one application.

23. The device claim 17, wherein each of the plurality of communication sessions involves an instance of the at least one application at the server.

24. The device of claim 17 further comprising:
means for transmitting the test input in each communication session to the server.

25. The device of claim 17, wherein the processing means is adapted to start the playing of the test input in at least two communication sessions with a time offset.

26. The device of claim 17, wherein the processing means is adapted to establish each of the plurality of communication sessions based on statistical user behavior data.

27. The device of claim 17, wherein the processing means is adapted to start the playing of the test input in a communication session based on statistical user behavior data.

28. The device of claim 19, wherein the test input means is adapted to produce the test input with modified time intervals between the individual user input operations.

29. The device of claim 28, wherein the modified time intervals are compressed time intervals between the individual user input operations.

30. The device of claim 28, wherein the modified time intervals are expanded time intervals between the individual user input operations.
